(19) United States
(12) Patent Application Publication
(10) Pub. No.: US 2009/0119352 A1
(43) Pub. Date: May 7, 2009

(54) Method for Optimizing Generational Garbage Collection Through Object Life Heuristics

(76) Inventors: Steven Joseph Branda, Rochester, MN (US); William Thomas Newport, Rochester, MN (US); John Joseph Stecher, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/935,091

(22) Filed: Nov. 5, 2007

(51) Int. Cl. G06F 17/30

(52) U.S. Cl. 707/205; 707/E17.005

(57) ABSTRACT

A method and apparatus to determine if an object should be instantiated in a nursery space or in a long lived space. Information as to real or estimated longevity of an object instantiated from a class is used to cause instantiation in the long lived space if the object instantiated is likely to be relatively long lived. Otherwise, default instantiation is made to a nursery space in which frequent garbage collection is performed to free up space by eliminating objects that are no longer used.

### FIELD OF THE INVENTION

This invention relates generally to memory allocation of objects, and, more particularly, to optimizing allocation of objects in different areas of storage.

### SUMMARY OF EMBODIMENTS OF THE INVENTION

Many modern computer systems use an object instantiation scheme having a nursery space in which objects are instantiated (allocated), and a long lived space in which particular objects are migrated if the nursery space is becoming full and the particular objects are still required. Significant amounts of time are spent instantiating objects in the nursery space and later moving the particular objects to the long lived space via a garbage collector routine. In some situations, SLAs (Service Level Agreements) may be violated because objects are being moved by the garbage collector from the nursery space to the long lived space. This is because movement of objects takes time and computer resource that otherwise would be available to service user requests.

In an embodiment of the present invention, objects that are likely to be long lived are instantiated directly into the long lived space, thereby avoiding a requirement to move those objects.

In an embodiment of the invention, a designer of a class knows that objects instantiated from that class will tend to be relatively long lived and a user interface is provide to allow the user to include metadata in the class that will be interpreted during instantiation of objects of this class into the long lived space.

In an embodiment of the invention, call stack information is kept for one or more objects. Lifetimes of those objects are observed, and if it is determined that a particular object is instantiated after a particular pattern in the call stack, and that particular object is determined to be relatively long lived, future instantiations of that object following the particular call stack pattern will be instantiated in long lived space.

In an embodiment of the invention, an instantiation of a particular object after a particular call stack pattern will be relatively long lived call stack profiles are created that will be examined when instantiating the particular object.

### BRIEF DESCRIPTION OF THE DRAWINGS

FIG. 1 shows a block diagram of a computer system comprising embodiments of the invention.

FIG. 2A shows a block diagram of a class further comprising metadata.

FIG. 2B shows a block diagram illustrating instantiation of objects, the instantiation including use of metadata in classes to determine location of instantiation.

FIG. 3 shows a processor having a call stack, an instantiator, and one or more call stack profiles.

FIG. 4 is a block diagram showing more detail of a call stack profile.

FIG. 5 illustrates how an instantiator uses a call stack and one or more call stack profiles to determine where to instantiate an object.

FIG. 6 is a flow chart illustrating a method embodiment of the invention in which metadata is used to determine placement of an instantiation of an object.

FIG. 7 is a flow chart illustrating a method embodiment of the invention in which metadata is added to a class based on determined lifetime of an object.

FIG. 8 is a flow chart illustrating a method embodiment of the invention in which one or more call stack profiles are compared to a call chain.

FIG. 9 is a flow chart illustrating a method embodiment of the invention in which a call stack profile is created.

FIG. 10 shows a computer readable media having a program product that, when executed, performs a method embodiment of the invention.

FIG. 11 is a block diagram of a user interface by which a user enters metadata into a class.

FIG. 12 is a block diagram of a user interface by which a user enters a call stack profile.

### DETAILED DESCRIPTION OF THE EMBODIMENTS

In the following detailed description of the embodiments of the invention, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

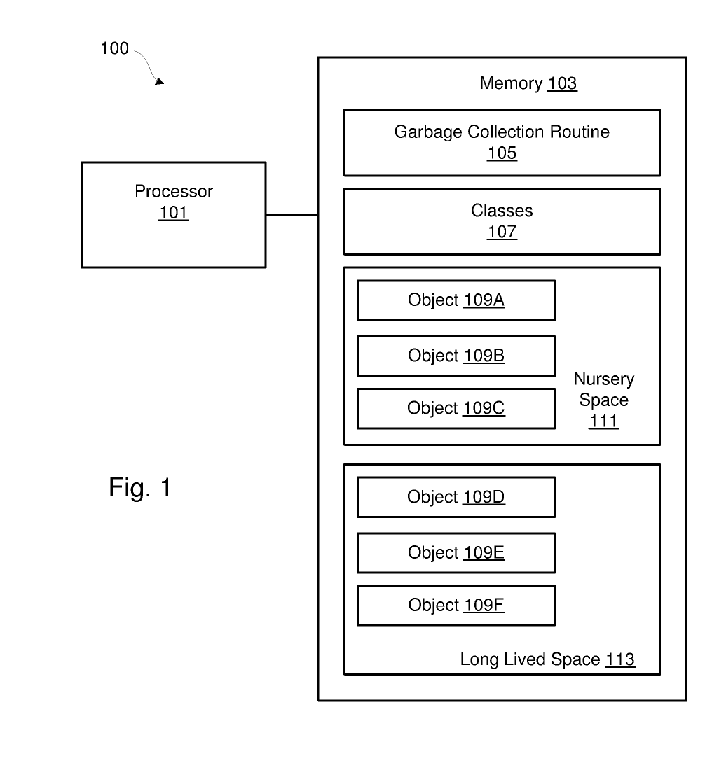

With reference now to the drawings, and, in particular, FIG. 1, computer system 100 is shown. Computer system 100 includes a processor 101 and a memory 103. Modern computer systems often comprise a plurality of processors and a memory hierarchy (e.g., levels 1-4 cache and one or more disks to store data and programs). A typical modern computer system 100 further includes many other components, such as networking facilities, user interfaces, and the like, all of which are well known and discussion of which is not necessary for understanding of embodiments of the invention.

Memory 103 represents all levels of storage for computer system 100, and any particular portion of data or instruction code may, at a given time, be on a disk, a main store, or in a level of cache.

Memory 103 further comprises a garbage collection routine 105 that is a process for identifying unused areas of memory. Classes 107 define the abstract characteristics of a thing (object), including the thing's characteristics (attributes, fields, or properties) and the thing's behaviors. Objects 109 (shown as Objects 109A-109F) are instantiations of a class or classes. A nursery space 111 is used to instantiate objects having an unknown lifespan (objects 109A-109C). A long lived space 113 is used to instantiate objects known to have a likelihood of a relatively long lifespan (109D-109F). In addition, objects in nursery space 111 may be initially instantiated in nursery space 111 but moved to long lived space 113 if those objects are found to be relatively long lived in order to make room for new object instantiation in nursery space 111. Nursery space 111 is intended to be “scratchpad” space, which garbage collection routine 105 frequently examines in order to free up space for instantiation of new objects.

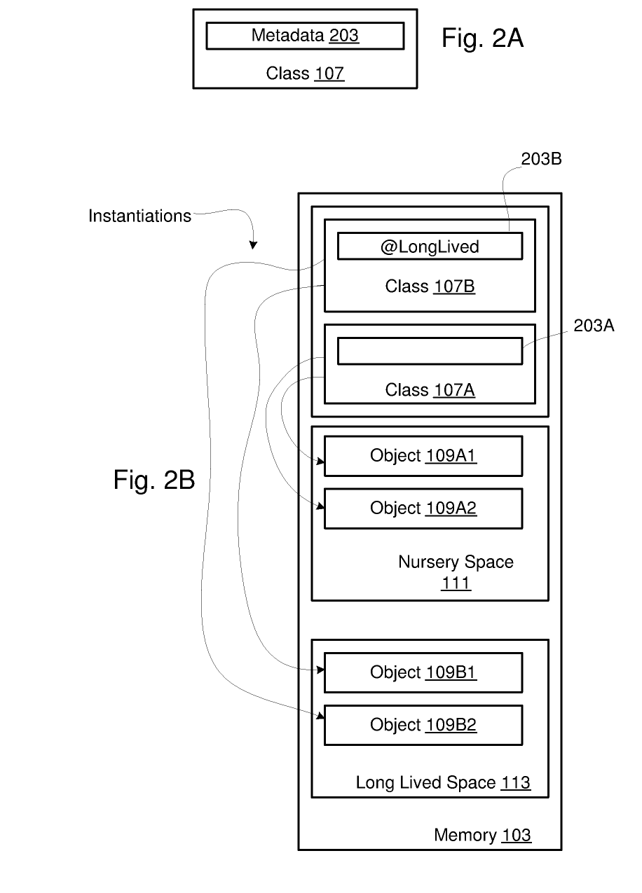

Turning now to FIG. 2A, a class 107 is shown to further comprise a metadata 203. Metadata field 203 is used by a designer of class 107 when the designer knows that objects instantiated from the class 107 are expected to be relatively long lived. “Relatively long lived” is a specified time period (e.g., minutes, hours, days, or months), as specified by a designer or administrator. “Relatively long lived” does not mean that every instantiation of a relatively long lived object is certain to last for the specified time period; rather, “relatively long lived” means that, statistically, such objects typically last for the specified time period. For example, if the designer or administrator expects that 80% of instantiations of such object will last for the specified time period, the designer or administrator codes appropriate metadata information into a class from which such relatively long lived objects are instantiated. For example, “@LongLived” found in metadata field 203 of class 107 will cause object instantiation to be placed in long lived space 113; if metadata field 203 does not exist, or “@LongLived” is not found in metadata field 203 of class 107, object instantiation will be placed in nursery space 111.

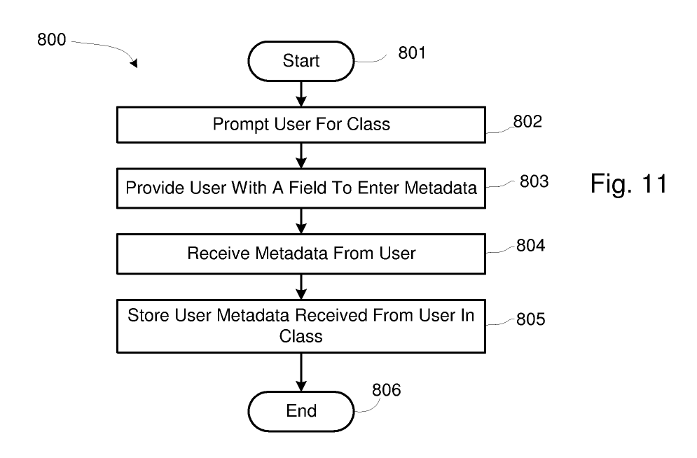

A method 800 is shown in FIG. 11 that provides a user interface by which the designer or administrator enters the metadata. Method 800 starts at block 801. In block 802, the user interface prompts the user (designer or administrator) for a class. In block 803, the user is provided with a field to enter metadata (e.g., a field to type into or one or more menu fields from which to select). In block 804 metadata is received from the user, for example, from a keyboard entry or from menu selection. In block 805, metadata provided by the user is stored with the class. Block 806 ends method 800.

FIG. 2B shows Memory 103 having classes 107A and 107B, nursery space 111 and long lived space 113. Class 107A is shown to have nothing in metadata 203A. Class 107B is shown to have “@LongLived” in metadata 203B. Objects 109B1 and 109B2 are instantiated from class 107B. Because “@LongLived” exists in metadata 203B, objects 109B1 and 109B2 are instantiated in long lived space 113. Objects 109A1 and 109A2 are instantiated from class 107A into nursery space 111 because class 107A does not have “@LongLived” in metadata 203A.

Metadata 203A may be lacking completely from class 107A, or may exist but not contain “@LongLived”. It may be that some or all objects instantiated from class 107A do in fact last a relatively long time. If so, these objects will eventually be migrated by garbage collection routine 105 from nursery space 111 to long lived space 113.

Another embodiment of the invention utilizes a relationship between an object to be instantiated and a call stack pattern that exists when the instantiation of the object occurs. If that call stack pattern and the instantiated object produces objects that are relatively long lived, future instantiations of the object, when that call stack pattern exists, are instantiated into long lived space 113 instead of nursery space 111, as explained below.

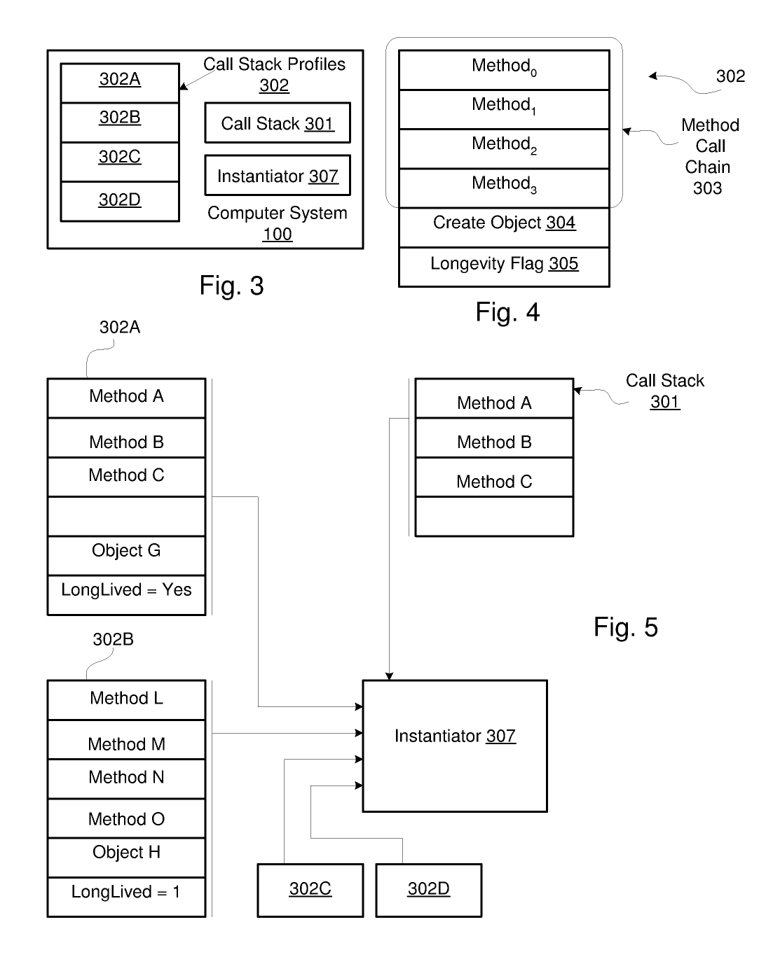

FIG. 3 shows computer system 100 having a call stack 301, an instantiator 307, and one or more call stack profiles 302 (shown as call stack profiles 302A-302D). Call stack 301 and call stack profiles 302 may be in registers in processor 101 or may be in memory 103. Instantiator 307 is typically program code that instantiates objects using classes.

Call stack 301 is a stack containing a history of methods called prior to an instantiation of an object. For example, Method A called Method B which called Method C which instantiates object X. Instantiator 307 is a routine that will instantiate an object. Call stack profile(s) 302 contain call stack patterns, an object identification, and information as to where to instantiate the object. FIG. 4 shows call stack profile 302 in more detail. Call stack profile 302 comprises a method call chain 303 that identifies a call stack pattern (e.g., Method A calls Method B calls Method C). It will be understood that whereas FIG. 4 shows method call stack chain 303 to have room for four Method calls (Method₀, Method₁, Method₂, and Method₃,) more or fewer capacities for method calls in method call chain 303 are contemplated. In addition, method call chain 303 may be embodied as a linked list, allowing an arbitrary number of method calls to be retained. Create object 304 is an identification of the object to be instantiated; for example, by naming the class used to create the object. Longevity flag 305 contains information used to determine whether the object to be instantiated is to be placed in nursery space 111 or in long lived space 113. Longevity flag 305 may be a simple binary bit. For example, “1” may mean the object is to be placed in long lived space 113; “0” may mean the object is to be placed in nursery space 111. Alternatively, longevity flag 305 may be text information, such as, “@LongLived”. Longevity flag 305 may be any information that directs whether the object to be created is created in nursery space 111 or in long lived space 113.

FIG. 5 illustrates how instantiator 307 uses one or more call stack profiles 302 and call stack 301. A particular object, “Object G” is to be instantiated by Method C, which was called by Method B, which was called by Method A as recorded in call stack 301 in FIG. 5. Call stack profile 302A has a method call chain 303 that matches current call stack 301 contents. Call stack profile 302A indicates that the object type it pertains to is “Object G”. Call stack profile 302A indicates that if the object to be created is “Object G” and call stack 301 matches the method call chain 303 of call stack profile 302A then the instant “Object G” is to be instantiated in long lived space 113. Since a match occurs, instantiator 307 therefore instantiates the instant “Object G” in long lived space 113. Call stack profile 302B has a method call chain 303 that does not match the current call stack 301 and therefore does not influence where the instant “Object G” is placed by instantiator 307. For simplicity, call stack profiles 302C and 302D are not shown in detail in FIG. 5.

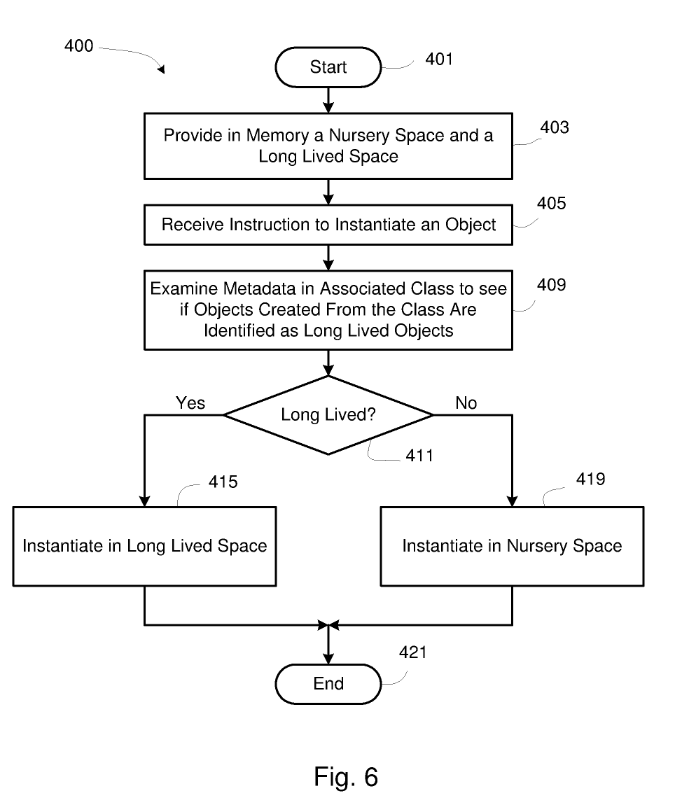

FIG. 6 illustrates a method 400 embodiment of the invention. Method 400 begins at block 401.

In block 403, a nursery space (such as nursery space 111 in FIG. 1) is provided and a long lived space (such as long lived space 113 in FIG. 1) is provided. The nursery space, as explained earlier, is a “scratchpad” space wherein objects are instantiated by default. The nursery space is “garbage collected” on a relatively frequent basis to find objects that are no longer used. If a particular object in the nursery space remains used for a long enough duration, as defined by a designer or administrator, that object is moved to the long lived space.

In block 405, method produces an instruction to instantiate an object, using a class.

In block 409, the method (or an instantiator called by the method) examines metadata in the class to see if the metadata contains any directions to guide the method (or instantiator) as to where to create the object.

In block 411, if the metadata in the class indicates that objects instantiated from the class are to be placed in the long lived space, block 415 instantiates the object in the long lived space. If the metadata in the class does not indicate that objects instantiated from the class are to be placed in the long lived space, block 419 instantiates the object in the nursery space.

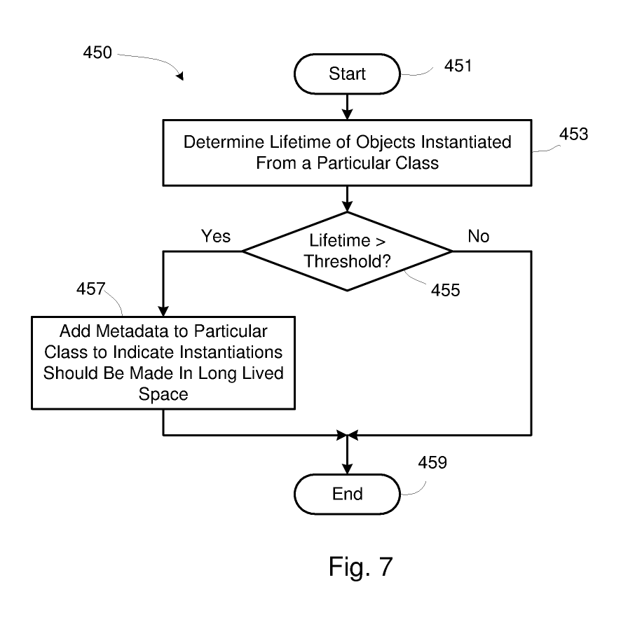

Block 421 ends method 400.

Whereas metadata in a class can be manually created by a designer who knows that objects instantiated from a particular class are likely to be long lived, it is also possible for the metadata to be automatically added to the class. Method 450 (shown in FIG. 7) illustrates, at a high level, how this is done.

Block 451 begins method 450. In block 453, lifetimes of objects instantiated from a particular class are determined. Block 453 may be performed for more than one class. Block 453 keeps track of objects created, including a time (e.g., time of day) when each object is created. If a sufficient number of objects instantiated (or a significant fraction of objects created) from a particular class last longer than an interval specified by a designer or administrator, the method that uses the class to instantiate the object adds metadata to the particular class as described earlier to indicate that such objects are to be instantiated directly into the long lived space (shown in FIG. 1 and described earlier). Alternatively, objects that are moved from the nursery space to the long lived space at least a specified fraction (e.g., 80% of such objects are eventually moved from the nursery space to the long lived space) cause the method that instantiates the object to modify the class to include metadata that indicates that such objects should be instantiated in the long lived space.

If the lifetime of such objects, as measured by real “wall clock time”, or by fraction of instantiations that are eventually moved from the nursery space to the long lived space, is greater than a threshold specified by a designer or administrator, thereby designating such objects as having a relatively long lifetime, block 455 transfers to block 457 which adds the metadata to any particular class from which a particular object usually is relatively long lived. If the lifetimes of other objects instantiated by other classes have relatively short lifetimes, block 455 does nothing, and future instantiations of objects from such other classes continue to be made in the nursery space. Block 459 ends method 450.

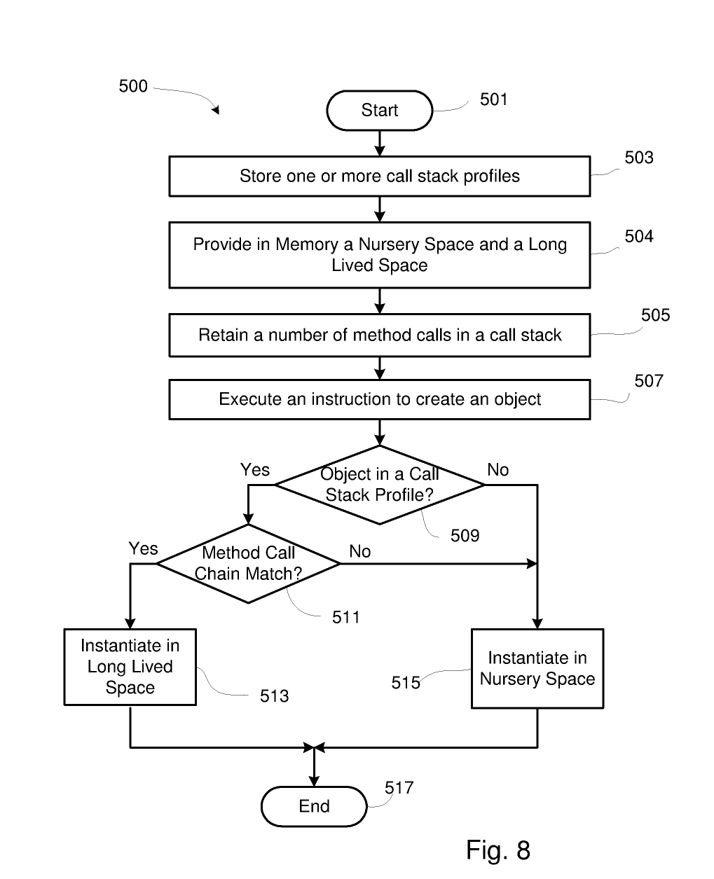

An alternative embodiment of the invention, method 500, is illustrated in FIG. 8. Method 500 is a method embodiment of the block diagrams shown in FIGS. 3, 4, and 5, in which one or more call stack profiles are created (manually or automatically). Objects are instantiated by an instantiator using the call stack profiles, method call history in a call stack, and object type to be instantiated to determine where the object is to be created.

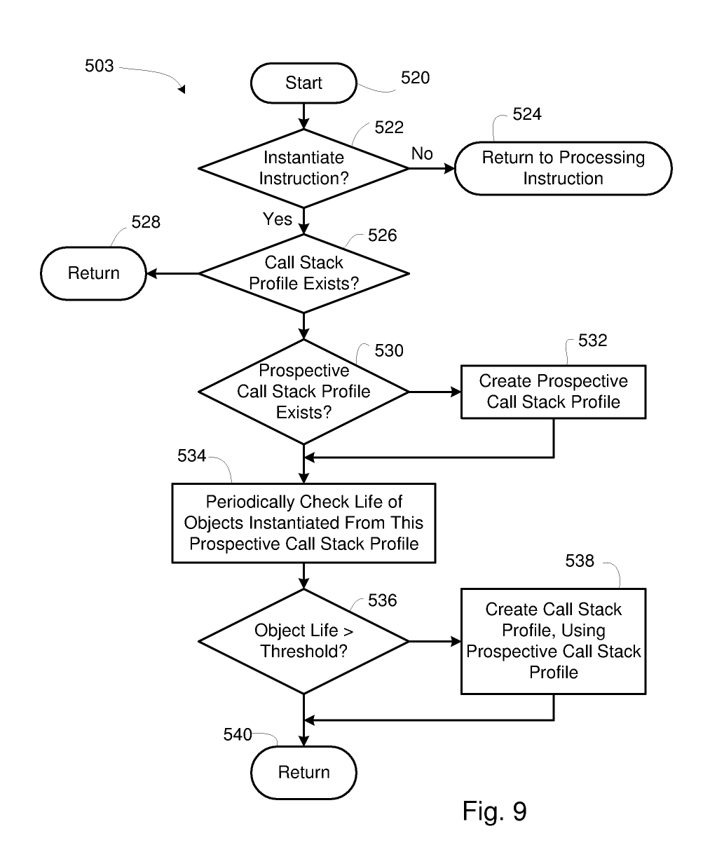

Method 500 begins at block 501. In block 503, one or more call stack profiles are created. Each call stack profile contains a method call chain describing a list of methods that have been called prior to an instantiation of an object. For example, the stack profile might specify: Method A called Method B which called Method C which is instantiating Object G. The stack profile further includes a “create object” to identify what object is to be associated with the list of methods that have been called and a longevity flag that directs instantiation to occur in the nursery space or the long lived space. Call stack profiles may be manually coded by a designer or administrator with knowledge that particular method call patterns will create a relatively long lived object. Alternatively, as described above, if particular objects are found to be long lived (for examples, using a timer, or observing what fraction of such objects have to be moved from the nursery space to the long lived space) a call stack profile may be created for the object automatically, as will later be described in more detail with reference to FIG. 9.

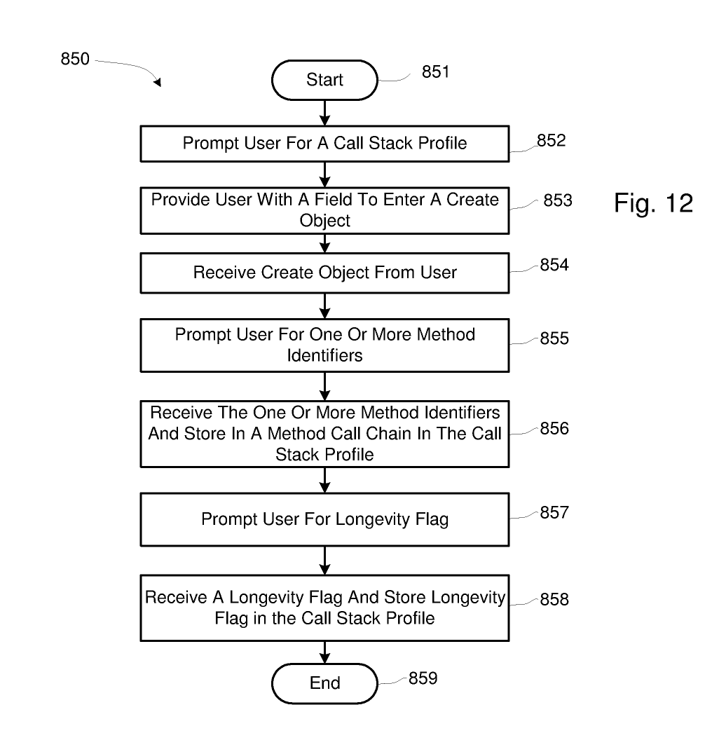

FIG. 12 shows method 850 which provides a user interface that allows the designer or administrator to manually code a call stack profile. Method 850 begins at block 851. Block 852 prompts the user to begin coding a call stack profile. Block 853 provides the user with a field (or a menu) to enter a create object (such as create object 304 in FIG. 4) which identifies what object is associated with the current call stack profile. Block 854 receives a create object from the user and stores it in the current call stack profile. Block 855 prompts the user for one or more method identifiers by providing one or more fields, or one or more items to select from a menu. Block 856 receives one or more method identifiers from the user and stores the method identifiers in a method call chain (method call chain 303 shown in FIG. 4). Block 857 prompts the user for a longevity flag, presenting a field or a menu to the user. Block 858 receives a longevity flag from the user and stores the longevity flag in the call stack profile. Block 859 ends method 850.

Block 504 provides a nursery space and a long lived space, as described earlier.

In block 505, one or more method calls are retained in a call stack (e.g., call stack 301 in FIG. 5). For example, during execution of a program, Method A called Method B which in turn called Method C.

In block 507 a method produces an instruction to create an object. For example, Method C of the previous paragraph must create an Object G.

In block 509, a check is made to see if the object to be created (Object G in the example) is found in any of the one or more call stack profiles. If not, the object to be created is created in the nursery space by block 515. If the object to be created is found in one (or more) of the call stack profiles, control passes to block 511. If the method call pattern found in the method call chain(s) matches the present pattern in the call stack, and the object to be created matches the “create object” identified in a call stack profile having a method call pattern match, the object to be created is instantiated in the long lived space using block 513; otherwise, block 515 instantiates the object to be created in the nursery space. Block 517 ends method 500.

FIG. 9 illustrates method 503 is an expanded view of an embodiment of block 503 of FIG. 8 which shows how call stack profiles may be automatically generated. Prospective call stack profiles are created for call stack patterns resulting in objects that may (or may not) tend to be relatively long lived. A prospective call stack profile is similar to a call stack profile, and contains a method call chain and a create object. A longevity flag is not required; however information may be kept with each prospective call stack profile to indicate how beneficial it might be to promote the prospective call stack profile to a call stack profile. For example, average lifetime of objects instantiated using the method call chain of a prospective call stack profile would indicate benefit (or non-benefit). As a second example, storing a fraction of times objects instantiated using the method call chain of a prospective call stack profile are moved from the nursery space to the long lived space would indicate benefit (or non-benefit). During execution of a program if sufficient longevity of objects created matching a particular prospective call stack profile, the prospective call stack profile is promoted to a call stack profile, which is used as described with reference to FIG. 8. Method 503 begins at block 520.

In block 522, if a current instruction does not instantiate an object, block 524 simply returns to normal processing of the current instruction. If the current instruction does instantiate an object, control passes to block 526. Block 526 checks to see if a call stack profile exists for the object to be instantiated. If so, block 528 returns control to normal instantiation processing, as described in the earlier discussion with reference to FIG. 8. If a call stack profile does not exist for the object to be instantiated, control passes to block 530.

In block 530, a check is made to see if a prospective call stack profile exists for the object to be instantiated. If not, a prospective call stack profile is created in block 532.

In block 534, lifespan of objects created from each prospective call stack profile is observed (for examples, as described above, by actually timing the lifespan of such objects, or, alternatively, by observing what fraction of such objects are moved from the nursery space to the long lived space). In block 536, if lifespan of a particular object in a particular prospective call stack profile exceeds a threshold specified by a designer or administrator, a call stack profile is created in block 538. Block 540 ends method 503.

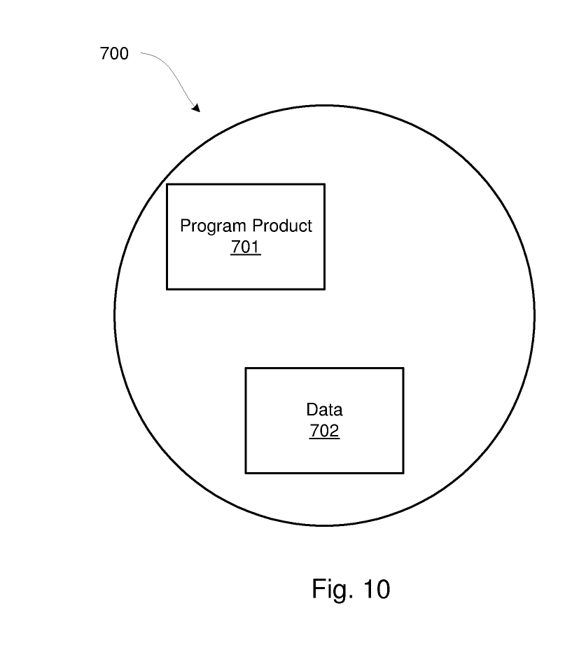

FIG. 10 illustrates a computer readable medium 700, such as a CD ROM, a DVD, a magnetic tape, hard disk, flash memory, and the like, upon which is encoded a program product 701 that, when executed by a suitable computer, performs one or more of the method embodiments of the invention described above. Data read by or created by program product 701 may be stored in data 702.

What is claimed is:

1. A method for instantiation of an object in a computer system having a nursery space in memory and a long lived space in memory comprising:
instantiating an object having a relatively long lifespan in the long lived space; and
instantiating an object not having a relatively long lifespan in the nursery space.

2. The method of claim 1, further comprising determining that a particular object has a relatively long lifespan.

3. The method of claim 2, determining that a particular object has a relatively long lifespan further comprising providing metadata in a class used to instantiate the particular object, the metadata directing instantiation of the object to either the nursery space or the long lived space.

4. The method of claim 3, wherein a user interface is provided to allow a user to enter the metadata in the class.

5. The method of claim 3, wherein the metadata is automatically added to the class based on measuring object lifetime during program execution.

6. The method of claim 5, wherein measuring object lifetime comprises using a timer to measure how long an object exists.

7. The method of claim 5, wherein measuring object lifetime comprises determine a fraction of instantiations of the particular object that are moved from the nursery space to the long lived space.

8. The method of claim 1, further comprising:
creating one or more call stack profiles, each call stack profiles including a pattern of method calls, a create object, and a longevity flag.
processing an object to be instantiated, the processing comprising:
examining create objects in one or more call stack profiles for a match with the object to be instantiated; and
if a match of the object is found with the create object in a particular call stack profile, then
comparing a current call stack with a method call chain in the particular call stack profile; and
if a match of the current call stack is found in the particular call stack profile then using the longevity flag in the particular call stack profile to direct instantiation of the object.

9. The method of claim 8, wherein creating the one or more call stack profiles is provided through a user interface.

10. The method of claim 8, wherein creating the one or more call stack profiles is done based on one or more usage patterns during program execution.

11. The method of claim 10, further comprising:
creating a prospective call stack profile for a particular object and a particular method call chain pattern;
periodically checking lifespan of objects created using a method call chain in the prospective call stack profile; and
If lifespan of objects created using the method call chain in the prospective call stack profile is longer than a specified threshold, then using the prospective call stack profile to create a call stack profile.

13. The method of claim 12, wherein the lifespan of objects created using the method call chain in the prospective call stack profile is determined by using a timer.

14. The method of claim 12, wherein the lifespan of objects created using the method call chain in the prospective call stack profile is determined based on a fractional value of objects created that are moved from the nursery space to the long lived space.

15. A computer readable medium comprising a program product, the program product, when executed by a suitable computer, performing the method of claim 1.
